(19) United States
(12) Patent Application Publication
(10) Pub. No.: US 2016/0125027 A1
(43) Pub. Date: May 5, 2016

(54) SEARCH SYSTEM, SEARCH PROGRAM, AND SEARCH-CONDITION INPUT METHOD

(71) Applicant: NOMURA RESEARCH INSTITUTE, LTD., Tokyo (JP)

(72) Inventor: Soichi OHARA, Tokyo (JP)

(73) Assignee: NOMURA RESEARCH INSTITUTE, LTD., Tokyo (JP)

(21) Appl. No.: 14/993,465

(22) Filed: Jan. 12, 2016

Related U.S. Application Data
(63) Continuation of application No. PCT/JP2013/069822, filed on Jul. 22, 2013.

(51) Int. Cl. G06F 17/30; G06F 3/0482; G06F 3/0488

(52) U.S. Cl. CPC G06F 17/30398; G06F 3/0488; G06F 17/3097; G06F 3/0482

(57) ABSTRACT

A search system with which a user can carry out an easy and quick operation by specifying a plurality of keywords by touch operations. The search system includes a keyword extracting unit that extracts an option of a keyword and displays the option in a list on the touch panel, and a search-condition setting unit that sets a search condition based on an operation of the user with respect to the option of the keyword. When a first keyword is selected by a touch operation from the option of the keyword, if the user slides a touch position on the touch panel, the search-condition setting unit sets the search condition depending on a direction of the slide on an assumption that a search operator of AND or OR is specified between the first keyword and a second keyword further selected by the user thereafter.

### TECHNICAL FIELD

The present invention relates to a technique of a search in an information processing system, and particularly relates to the technique which is effective when applied to a search system, a search program, and a search-condition input method used in a touch device.

### BACKGROUND ART

In an information processing system, it is general to use search means for providing a search function of information to a user. In order to carry out a search, a user has to specify a search condition such as a keyword. Herein, depending on a usage scene of an information processing system, particularly in a case in which it is used at a site such as outside, various sites of production/sales, etc. other than offices, desks, etc., sometimes it is difficult or cumbersome to input or specify by typing a search condition by using an input device such as a keyboard.

On the other hand, for example, in some cases, a mechanism is used in which information of a search target is analyzed to extract words, etc. serving as options of a keyword for a search, and they are displayed in a list in a format such as a so-called tag cloud, thereby enabling a user to select and input a keyword and reducing the load of the user.

For example, Japanese Patent Application Publication Laid-Open No. 2010-160688 (Patent Document 1) describes a technique in which, in relation to many search target information stored in characteristics of the information included respectively in a plurality of items are displayed in a mixed manner on a display, the words are displayed with first display modes which are mutually different respectively for the items, furthermore, the words are displayed in a phased manner with mutually different second display modes, which are different from the first display modes, depending on a predetermined frequency, and search target information to which the words are given is searched in accordance with the search condition specified based on the selected words and is displayed on the display.

### RELATED ART DOCUMENT

### Patent Document

Patent Document 1: Japanese Patent Application Publication Laid-Open No. 2010-160688

### SUMMARY OF THE INVENTION

### Problems to be Solved by the Invention

By using the mechanism as described above in which the options of the keyword for searching are displayed in a list in the format of, for example, a tag cloud to enable the user to input a keyword by a selection operation is used, for example, when a search is to be carried out on a portable information terminal such as a tablet terminal having a touch panel (hereinafter, collectively referred to as “touch device” in some cases) used at job sites, etc., the user can easily input and specify a keyword for a search by a touch operation. Therefore, this is extremely effective.

However, in specification of the search keyword using a general tag cloud format, the keyword which can be specified by the user is only one in most cases. More specifically, at the point of time when the user selects one keyword from the tag cloud, a search is executed by using the keyword as a search condition, and results are displayed.

On the other hand, a mechanism which enables execution of an AND search or an OR search when the user specifies a plurality of keywords from among a plurality of keyword options displayed in the format of, for example, a tag cloud is employed in some cases. However, normally, this case requires a plurality of steps of operations, for example, an AND search or an OR search is specified via a radio button, a drop-down list, or the like after selecting one keyword, and another keyword is then selected, which is selection of the keyword and specification of a search method whether it is an AND search or an OR search; and, this is extremely cumbersome. Particularly, requiring the plurality of steps of operations even when there is only one keyword which is desired to be selected extremely impairs the operability and usability of the user.

Regarding the search method, for example, it is also possible to avoid specification, which is carried out every time, by setting either an AND search or an OR search as a default value; however, an operation is still required when the default value is to be changed. Moreover, when a keyword is selected, whether another additional keyword is to be further selected or not is unknown at the point of time; therefore, completion of selection of keywords, in other words, an operation of explicitly ordering execution start of a search is required, or an inefficient process of executing a search as needed based on the keyword(s) which have been selected until that moment every time a keyword is selected is required.

Therefore, it is an object of the present invention to provide a search system, a search program, and a search-condition input method which enable a user to carry out an easy and quick operation when an AND search or an OR search is to be carried out by specifying a plurality of keywords by touch operations from among a plurality of options of search keywords in a touch device.

The above and other objects and novel characteristics of the present invention will be apparent from the description of the present specification and the accompanying drawings.

### Means for Solving the Problems

The following is a brief description of an outline of the typical invention disclosed in the present application.

A search system according to a representative embodiment of the present invention relates to a search system that receives a search condition by a touch operation of a user on a touch panel possessed by a touch device, and has the following characteristics.

That is, the search system includes: a keyword extracting unit that extracts an option of a keyword for searching from information of a search target and displays the option in a list on the touch panel; a search-condition setting unit that sets a search condition based on an operation of the user with respect to the option of the keyword displayed in the list on the touch panel; and a search processing unit that executes or instructs a search based on the search condition.

When a first keyword is selected by a touch operation of the user from the option of the keyword displayed in the list on the touch panel, if the user slides a touch position on the touch panel, the search-condition setting unit sets the search condition depending on a direction of the slide on an assumption that a search operator of AND or OR is specified between the first keyword and a second keyword further selected by the user thereafter.

Further, the present invention can be applied to a program that operates a touch device as a search system described above.

### Effects of the Invention

Among the inventions disclosed in the application, the advantageous effects obtained by the representatives will be briefly explained as below.

That is, according to a representative embodiment of the present invention, a user can carry out an easy and quick operation when an AND search or an OR search is to be carried out by specifying a plurality of keywords by touch operations from among a plurality of options of search keywords in a touch device.

### BRIEF DESCRIPTIONS OF THE DRAWINGS

FIG. 1 is a diagram showing an outline of a configuration example of a search system, which is an embodiment of the present invention;

FIG. 2 is a diagram showing an outline of an example of a search screen in the embodiment of the present invention;

FIG. 3 is a diagram showing an outline of an example of an operation of a case in which only one keyword is specified to carry out a search in the embodiment of the present invention;

FIG. 4 is a diagram showing an outline of an example of an operation of a case in which a plurality of keywords are specified to carry out an AND search in the embodiment of the present invention; and

FIG. 5 is a diagram showing an outline of an example of an operation of a case in which a plurality of keywords are specified to carry out an OR search in the embodiment of the present invention.

### DETAILED DESCRIPTION OF PREFERRED EMBODIMENT

As below, embodiments of the invention will be explained in detail with reference to the drawings. Note that, in all drawings for explanation of the embodiments, the same members basically have the same signs and their repetitive explanation will be omitted.

A search system which is an embodiment of the present invention is a system which receives specification of a search condition by a touch operation of a user and executes a search with respect to a business application or the like which works on a touch device. In order to enable reception of specification of a search keyword(s) by the touch operation of the user, in the present embodiment, information of search targets is analyzed to extract words, etc.

serving as options of keywords, and these are displayed in a list such that each of them can be selected in the format of, for example, a tag cloud. The user selects one or more keyword(s) from among the options of the keywords displayed in the list by a touch operation, and, in this process, a search method whether it is an AND search or an OR search can be specified in combination with selection of the keyword by an operation of, for example, a so-called flick input. As a result, an easy and quick input operation of a search condition is realized without the need of an additional operation for specifying the search method.

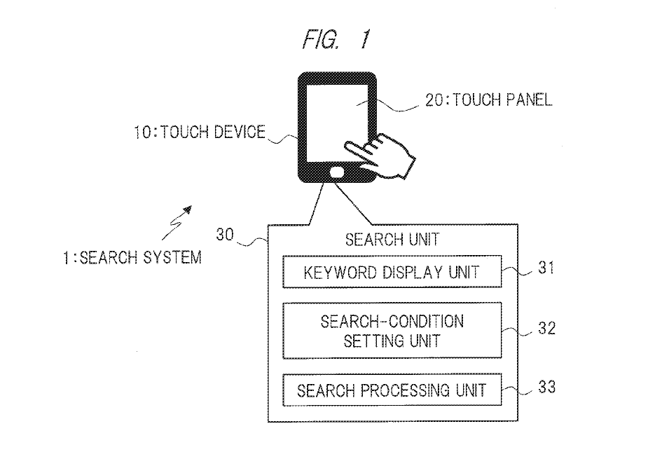

FIG. 1 is a diagram showing an outline of a configuration example of a search system, which is an embodiment of the present invention. The search system 1 includes, for example, a touch device 10 having a touch panel 20 such as a general-purpose tablet terminal or a portable business-dedicated terminal, and has a search unit 30 implemented as a software program, which works on an unshown OS (Operating System). The program may be recorded on the touch device 10 or may be downloaded from an application server via an unshown network and executed. The program may be a program which works on an application server and displays processing results on a touch panel 20 of the touch device 10.

The search unit 30 provides a search function of various information to an unshown business application, etc., which operate on the touch device 10 or on an application server connected via an unshown network, and the search unit 30 has units such as a keyword display unit 31, a search-condition setting unit 32, and a search processing unit 33.

The keyword display unit 31 has a function to analyze the information of a search target according to the search unit 30 in advance, extract words, etc. serving as options of the keyword, and display a list of the words, etc. on the touch panel 20 such that each of them can be selected in a format of, for example, a tag cloud. The method of extracting the options of the keyword from the information of the search target and the method of displaying the extracted options of the keyword in the format of the tag cloud are not particularly limited, and publicly known methods can be appropriately used.

The search-condition setting unit 32 has a function to acquire the information of the keyword(s) selected by a touch operation of a user from the options of the keyword displayed in the list on the touch panel 20 and set the information as a search condition. In the present embodiment, as described later, one or more keyword(s) can be selected, and, herein, regarding the specification of the search method whether an AND search or an OR search is to be carried out, it can be specified by the user by, for example, a flick input when the keyword(s) is selected. As a result, without the need of additionally specifying a search method in addition to selection of the keyword(s) or additionally explicitly specifying that there is no other keyword to be specified, in other words, that a search is to be executed by using the currently selected keyword(s), the operation of the user is facilitated, and the search condition can be quickly input.

The search processing unit 33 has a function to execute a search process based on the search condition including the search keyword(s) and the search method, which have been received by the search-condition setting unit 32. A method of executing the search is not particularly limited, and publicly known techniques can be appropriately applied, for example, extraction is carried out based on the search condition from the information of the search target accumulated in an unshown database, file table, etc., or execution of the search process is ordered with respect to, for example, a search engine provided by an application server.

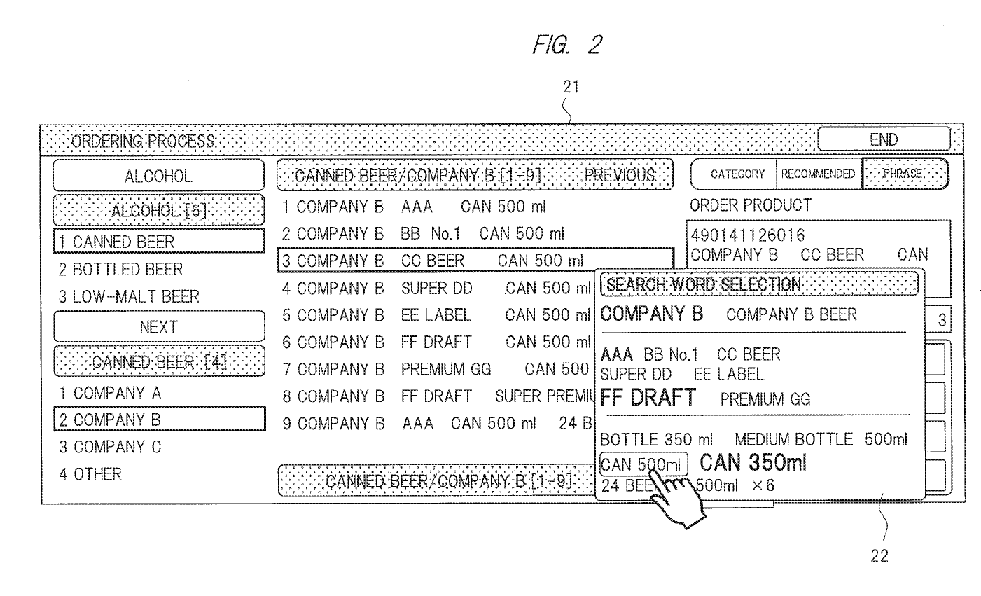

FIG. 2 is a diagram showing an outline of an example of a search screen of the present embodiment. Herein, as a screen of a business application which works on the touch device 10, a screen of a case in which a person in charge places a replenishment order of consumed products in an in-store display rack of, for example, a supermarket by using the touch device 10 is taken as an example.

At an in-store job site, a user operates an order processing screen 21, which is shown on the touch panel 20 of the touch device 10 and shown in the figure, to search and specify a product(s) serving as an order target(s). Specifically, in the order processing screen 21, first, in the region of a left column of the screen, the category of the product registered in a product master is selected and narrowed down in accordance with a hierarchical structure. The example of FIG. 2 shows a state in which “alcohol” is selected as a large category of the product, “CANNED BEER” is selected as a medium category from among six items included in the category, and, furthermore, the item of “Company B” is selected as a small category from among four items included in the category.

At this point, in the region of a central column of the screen, a list of products (product names) included in the category “ALCOHOL>CANNED BEER>COMPANY B” selected in the region of the left column is displayed. However, if the products displayed in the list herein are so many that the entirety thereof cannot be referenced without carrying out operations such as scrolling and page feed repeatedly, narrowing-down has to be further carried out. Therefore, the user selects “phrase” by a button disposed in an upper part of the region of a right column of the screen. At this point, the search unit 30 causes the keyword display unit 31 to analyze the product names of the products included in the list, extract one or more search keywords, and display a list thereof on a search-word selection screen 22 in a format of, for example, a tag cloud shown in the figure.

When the user selects a keyword for narrowing down the product of the search target from among the list of the keywords displayed on the search-word selection screen 22, the search unit 30 acquires the information of the search condition including the information of the selected keyword by the search-condition setting unit 32 and carries out a search by the search processing unit 33. Based on the search results thereof, the business application narrows down the list of the products displayed in the central column of the screen to the products including the keyword in the product names thereof and displays them.

For example, the example of FIG. 2 shows that, when the user selects “CAN 500 ml” on the search-word selection screen 22 as a search keyword, in the list of the products of the central column of the screen, only the products including the word “CAN 500 ml” in the product names thereof are listed, and the number of the corresponding products is narrowed down to 9. Therefore, scrolling or page feed for seeing the entirety thereof is not required. By virtue of such narrow-down, an objective product (in the example of FIG. 2, “COMPANY B CC CANNED BEER 500 ml”) can be easily and quickly specified to carry out an ordering process.

Herein, the present embodiment enables a user to select one keyword as shown in the example of FIG. 2 from among a plurality of keywords displayed in a list on the search-word selection screen 22 and carry out a search and, in addition to that, enables a user to select a plurality of keywords and carry out an AND search or an OR search by using them quickly by an easy operation.

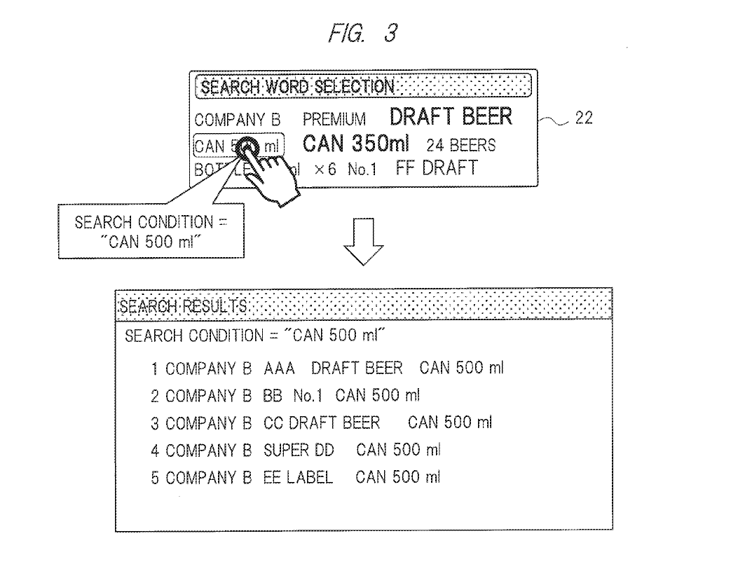

FIG. 3 is a diagram showing an outline of an example of an operation of a case in which only one keyword is specified to carry out a search in the present embodiment. If the user only simply touches the keyword (in the example of FIG. 3, “CAN 500 ml”), which is selected from among the list displaying the options of the keyword for a search in the format of, for example, a tag cloud on the search-word selection screen 22, and moves the finger or the like away therefrom, “CAN 500 ml” is set as a search condition. Then, it is assumed that there is no more keyword which is to be further added, a search of narrowing down products is immediately carried out based on the search condition, and search results are displayed.

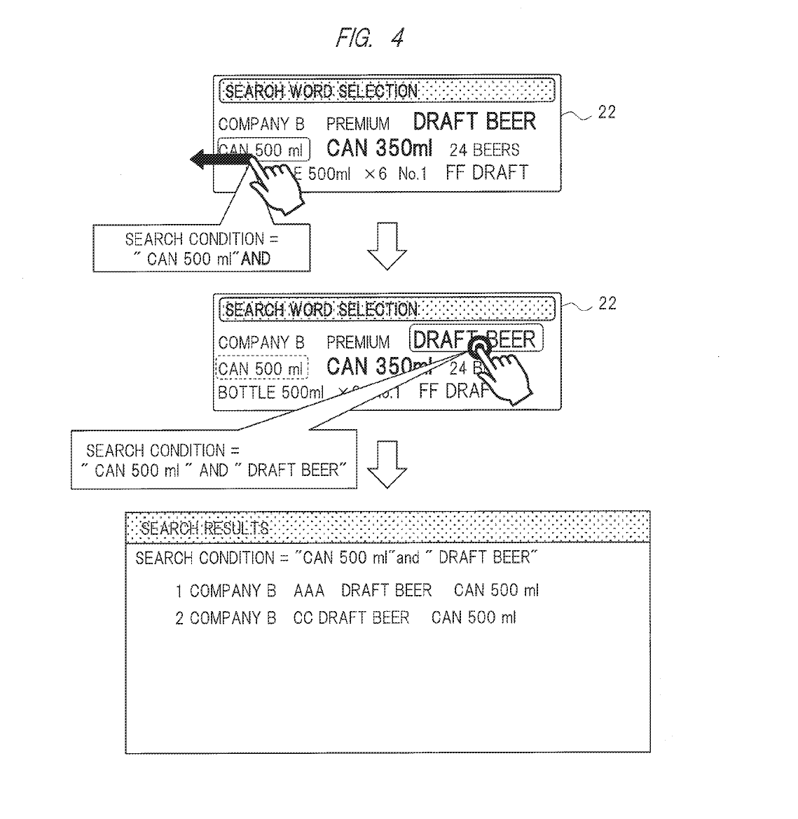

FIG. 4 is a diagram showing an outline of an example of an operation of a case in which a plurality of keywords are specified to carry out an AND search. When the user touches a keyword (in the example of FIG. 4, “CAN 500 ml”), which is selected first in the search-word selection screen 22, if the user, for example, slides the finger or the like to the left side, contents [“CAN 500 ml” AND] are set as a search condition. More specifically, the user can flick-input a search operator of “AND” by sliding a touch position from the keyword to the left side.

At this point of time, as shown in the example of FIG. 3, a search may be immediately carried out by using “CAN 500 ml” as the search condition, and tentative search results may be displayed. However, since the flick input has explicitly instructed that an additional keyword is to be specified, it is desired not to apply unnecessary load without carrying out the search at this point of time.

Then, when the user only simply touches a keyword selected next (“DRAFT BEER” in the example of FIG. 4) and moves the finger or the like away therefrom, the keyword is added to the search condition, and [“CAN 500 ml” AND “DRAFT BEER”] is set. At this point of time, it is assumed that an instruction that there is no specification of an additional keyword has been given. Therefore, a search of narrowing down products based on the search condition is immediately carried out by using the keyword as ending of the search condition, and search results are displayed. More specifically, they are narrowed down to the products including both of the words “CAN 500 ml” and “DRAFT BEER”.

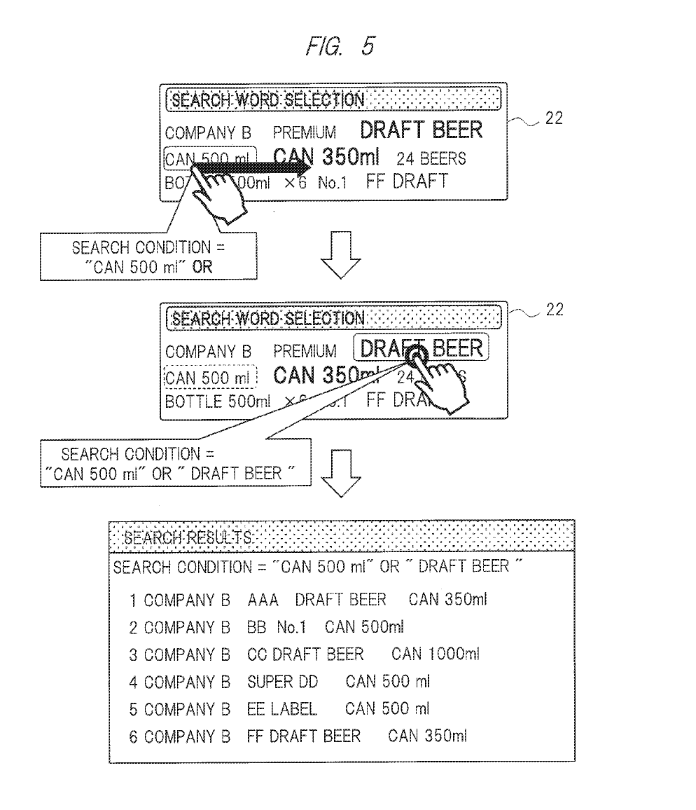

Similarly, FIG. 5 is a diagram showing an outline of an example of an operation of a case in which a plurality of keywords are specified to carryout an OR search. When the user touches a keyword which is selected first (in the example of FIG. 5, “CAN 500 ml”) in the search-word selection screen 22, if the user, for example, slides the finger or the like to the right side, contents [“CAN 500 ml” OR] are set as a search condition. More specifically, when the user slides the touch position from the keyword to the right side, a search operator “OR” can be flick-input.

Then, when the user only simply touches a keyword selected next (in the example of FIG. 5, “DRAFT BEER”) and moves the finger or the like away therefrom, the keyword is added to the search condition, and [“CAN 500 ml” OR “DRAFT BEER”] is set. At this point of time, it is assumed that an instruction that no additional keyword is to be specified has been given. Therefore, by using the keyword as the ending of the search condition, a search of narrowing down the products is immediately carried out based on the search condition, and search results are displayed. More specifically, the products are narrowed down to the products which include at least either word of “CAN 500 ml” and “DRAFT BEER”.

In FIG. 4 and FIG. 5, a case in which an AND search or an OR search is carried out for two keywords is taken as an example. However, three or more keywords can be sequentially specified to carry out an AND search(es) and/or an OR search(es). In this case, the search operator(s) of “AND” and/or “OR” are configured to be judged sequentially from the left side. Meanwhile, in the present embodiment, whether it is an AND search or an OR search is specified by a left/right flick input; however, as a matter of course, it may be an upward/downward flick input. Meanwhile, as an operation pattern of a flick input, for example, a specification may be carried out in a manner that, when the user continues touching a target keyword for a certain period of time or more, the search-condition setting unit 32 displays a screen for carrying out an input of selecting an AND search or an OR search around the keyword, and the user slides the touching finger or the like to select it.

As explained above, according to the search system 1, which is an embodiment of the present invention, since a business application or the like which works on the touch device 10 is enabled to receive a specification of a search keyword(s) by a touch operation(s) of a user, the information of a search target is analyzed to extract words, etc. serving as options of the keyword(s), and these are displayed in a list such that each of them can be selected in the format of, for example, a tag cloud. When the user is to select one or more keywords from among the options of the keywords displayed in the list by a touch operation, the user can specify, by one action, a search method whether it is an AND search or an OR search in combination with the selection of the keyword by, for example, a flick input. As a result, a simple and quick input operation of the search condition is enabled without the need of an additional operation for specifying the search method.

In the foregoing, the invention made by the inventors of the present invention has been concretely described based on the embodiments. However, it is needless to say that the present invention is not limited to the foregoing embodiments and various modifications and alterations can be made within the scope of the present invention. For example, the above embodiments are those described in detail in order to better illustrate the invention and are not intended to be limited to necessarily provide all the configurations described. Moreover, part of the configuration of the embodiment can be subjected to addition/deletion/replacement of other configurations.

### INDUSTRIAL APPLICABILITY

The present invention can be used in a search system, a search program, and a search-condition input method which are used in a touch device.

### REFERENCE SIGNS LIST

1 . . . SEARCH SYSTEM,
10 . . . TOUCH DEVICE,
20 . . . TOUCH PANEL, 21 ORDER PROCESSING SCREEN, 22 . . . SEARCH-WORD SELECTION SCREEN, 30 . . . SEARCH UNIT, 31 . . . KEYWORD DISPLAY UNIT, 32 . . . SEARCH-CONDITION SETTING UNIT, 33 . . . SEARCH PROCESSING UNIT.

1. A search system for receiving a search condition by a touch operation of a user on a touch panel possessed by a touch device, the search system comprising:
a keyword extracting unit that extracts an option of a keyword for searching from information of a search target and displays the option in a list on the touch panel; and
a search-condition setting unit that sets a search condition based on an operation of the user with respect to the option of the keyword displayed in the list on the touch panel;
wherein when a first keyword is selected by a touch operation of the user from the option of the keyword displayed in the list on the touch panel, if the user slides a touch position on the touch panel, the search-condition setting unit sets the search condition depending on a direction of the slide on an assumption that a search operator of AND or OR is specified between the first keyword and a second keyword further selected by the user thereafter.

2. The search system according to claim 1,
wherein when the first keyword is selected by the touch operation of the user, if the user does not slide the touch position on the touch panel, the search-condition setting unit sets the search condition using the first keyword as ending.

3. A search program for operating a touch device as a search system that receives a search condition by a touch operation of a user on a touch panel, the search program executing:
a keyword extracting process of extracting an option of a keyword for searching from information of a search target and displaying the option in a list on the touch panel; and
a search-condition setting process of setting a search condition based on an operation of the user with respect to the option of the keyword displayed in the list on the touch panel;
wherein when a first keyword is selected by a touch operation of the user from the option of the keyword displayed in the list on the touch panel, if the user slides a touch position on the touch panel, the search-condition setting process sets the search condition depending on a direction of the slide on an assumption that a search operator of AND or OR is specified between the first keyword and a second keyword further selected by the user thereafter.

4. A search-condition input method of receiving a search condition by a touch operation of a user on a touch panel of a touch device, the search-condition input method comprising:
a keyword extracting step that the touch device extracts an option of a keyword for searching from information of a search target and displays the option in a list on the touch panel; and
a search-condition setting step that the touch device sets a search condition based on an operation of the user with respect to the option of the keyword displayed in the list on the touch panel;
wherein when a first keyword is selected by a touch operation of the user from the option of the keyword displayed in the list on the touch panel, the search-condition setting step sets the search condition depending on a user's gesture thereafter on an assumption that a search operator of AND or OR is specified between the first keyword and a second keyword further selected by the user thereafter.
